(19) United States
(12) Patent Application Publication
(10) Pub. No.: US 2005/0268667 A1
(43) Pub. Date: Dec. 8, 2005

(54) Drum washing machine

(75) Inventors: Seong No Yoon, Changwon-si (KR); Bong Sang Lee, Changwon-si (KR); Sung Rak Gong, Busan (KR); Bo Yeon Kim, Changwon-si (KR); Seong Yeol Lee, Daegu (KR); Dae Hee Kwon, Busan (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/034,983

(22) Filed: Jan. 14, 2005

(30) Foreign Application Priority Data
Jun. 7, 2004 (KR) P2004-41224
Jun. 7, 2004 (KR) P2004-41223

(51) Int. Cl. B08B 3/12

(52) U.S. Cl. 68/3 R

(57) ABSTRACT

Disclosed is a drum washing machine comprising a top cover covering an upper surface of the washing machine, a panel frame provided on an upper front portion of the top cover, and at least one projecting member protruded rearward from the panel frame so as to support a front portion of the top cover.

### CROSS-REFERENCE TO RELATED APPLICATIONS

This application claims the benefit of Korean Application No. P2004-41223, and P2004-41224 both filed on Jun. 7, 2004, which is hereby incorporated by reference as if fully set forth herein.

### BACKGROUND OF THE INVENTION

1. Field of the Invention

The present invention relates to a drum washing machine, and more particularly, to a drum washing machine having a top cover more stably supported.

2. Discussion of the Related Art

In general, a washing machine is an apparatus for washing laundries using emulsification of detergent and friction caused by rotations of a pulsator or a drum. The washing machine includes a drum for accommodating laundries, in a cabinet including an exterior of the washing machine.

The washing machine is divided into a drum type washing machine, an agitator type washing machine, and a pulsator type washing machine.

The drum type washing machine includes a plurality of lifters protruded from an inner circumferential surface of the drum rotatably provided so as to be rotatable around an axis being horizontal.

The lifter raises or drops laundries accommodated in the drum when the drum is rotated. In this instance, washing is performed by friction between a current and the laundries.

The agitator type washing machine performs washing by agitating an agitator in a left and right direction, the agitator formed in a wing shape and protruded from the center of the drum.

The pulsator type washing machine performs washing by rotating a pulsator formed in a round plate shape. In recent years, the drum type washing machine has been increased, the drum type washing machine enabling to lower a total height of the washing machine and to prevent many wrinkles from occurring.

FIG. 1 illustrates a diagram showing a drum washing machine having a structure of a top cover mounted thereat, in accordance with a related art.

As illustrated in FIG. 1, the drum type washing machine in accordance with the related art includes a front cover 11, a door 12 provided at the center of the front cover 11, and a top cover 30 covering an upper surface thereof.

In this case, a control panel (not shown) is installed at an upper part of the front cover 11, and a panel frame 20 is provided for supporting a rear portion of the control panel. A front portion of the top cover 30 is coupled with the panel frame 20.

In more detail, a cover frame 31 is coupled with a border of the top cover 30 by inserting injection molding, and at least one projection 32 is provided on a front surface of the cover frame 31. The projection 32 is inserted into a hole 21 and supported by a brim of the hole 21, the hole 21 formed at the panel frame 20.

Accordingly, the projection 32 protruded from the front surface of the top cover 30 is inserted into the hole 21 formed at the panel frame 20 such that the panel frame 20 and the top cover 30 are strongly supported. In this case, when the cover frame 31 is coupled with the top cover 30 by the inserting injection molding, supporters such as the projection 32 is easily formed in front of the top cover 30.

The structure for coupling the top cover with the panel frame in accordance with the related art, however, has a problem that the structure is inapplicable when an enameled top cover is employed.

In other words, when the projection is formed on a surface of the enameled top cover which is enameled with a glass material in layers, the enameled layer may be scratched or damaged. Accordingly, there is a problem that the projection is unable to form on the enameled top cover.

### SUMMARY OF THE INVENTION

Accordingly, the present invention is directed to a drum type washing machine that substantially obviates one or more problems due to limitations and disadvantages of the related art.

An object of the present invention is to provide a drum type washing machine having as structure for stably supporting a top cover covered with enamel.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a drum washing machine comprising a top cover covering an upper surface of the washing machine, a panel frame provided on an upper front portion of the top cover, and at least one projecting member protruded rearward from the panel frame so as to support a front portion of the top cover.

The top cover includes an enameled sheet metal. The panel frame comprises a metal material and the projecting member is formed by applying a lancing process. A bending member is bent inward from a front border of the top cover and loaded on an upper surface of the supporting member.

In another aspect of the present invention, a drum washing machine comprises a panel frame provided at an upper front surface of the washing machine, and at least one supporting member provided at the panel frame so as to support a front portion of the top cover.

The supporting member comprises a body closely loaded to a rear surface of the panel frame so as to load a front portion of the top cover to an upper surface thereof, and a hook provided at the body and fixed on the panel frame.

The panel frame comprises at least one insertion hole, and the hook is inserted into the insertion hole and fixed therein. An end of the hook is restrained by a border of the insertion hole.

A protuberance is provided on a front surface of the body and inserted into a sunken member formed on a rear surface of the panel frame. At least one depressed member is formed on a surface of the body. The top cover comprises an enameled sheet metal.

The supporting member comprises polyacetal. A bending member bent inward is provided at a border of the top cover, the bending member loaded on an upper surface of the supporting member.

In another aspect of the present invention, a drum washing machine comprises a panel frame including an enameled sheet metal so as to cover an upper surface of the washing machine, a panel frame provided on an upper front surface of the washing machine, and at least one supporting member comprising a body closely loaded to a rear surface of the panel frame so as to load a front portion of the top cover to an upper surface thereof, and a hook provided at the body and fixed on the panel frame.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a perspective view showing an exterior of a drum type washing machine in accordance with the present invention;

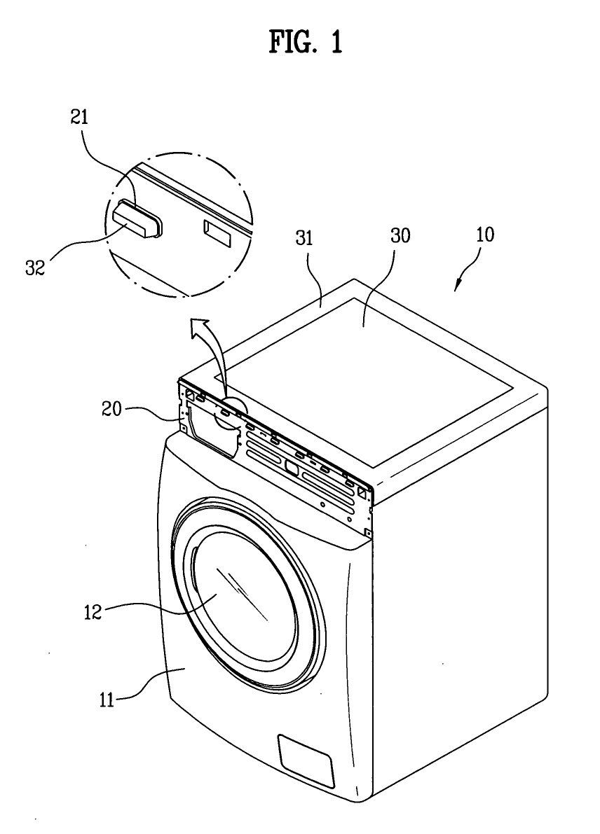

FIG. 2 illustrates a perspective view showing an exterior of the drum washing machine in accordance with the present invention;

FIG. 3 illustrates a perspective view showing a supporting structure of a top cover in accordance with a first embodiment of the present invention;

FIG. 4 illustrates a perspective view showing a supporting structure of a top cover in accordance with a second embodiment of the present invention;

FIG. 5 illustrates a perspective view showing a supporting member in accordance with the present invention; and

FIG. 6 illustrates a perspective view showing a sectional perspective view showing the supporting member coupled with a panel frame, in accordance with the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

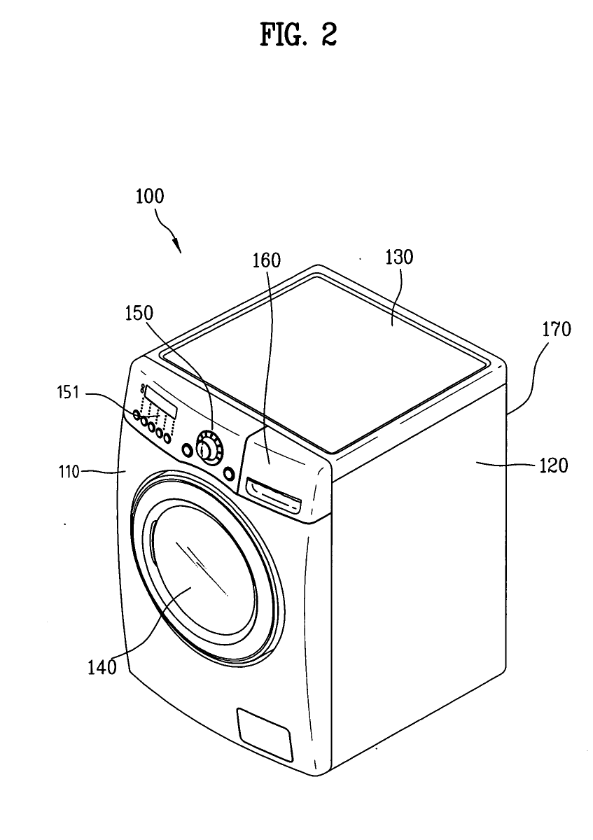

FIG. 2 illustrates a perspective view showing an exterior of the drum washing machine in accordance with the present invention. As illustrated in FIG. 2, the drum type washing machine in accordance with the present invention includes a front cover 110, a door 140 provided at the center of the front cover 110, a side cover 120 covering a side of the washing machine 100, and a top cover 130.

A control panel 150 is provided at an upper part of the front cover 110, and a detergent box 160 is provided at a side of the control panel. A displaying member 151 and various kinds of buttons are provided on a front surface of the control panel 150, the displaying member 151 for displaying operating conditions of the washing machine.

Furthermore, a panel frame is provided at a rear portion of the control panel 150 so as to reinforce stiffness of the upper front surface of the washing machine and to support a front portion of the control panel 150 and the top cover 130.

Meanwhile, a drum for accommodating laundries is rotatably provided in the drum type washing machine, and washing is performed by friction and emulsification of detergent, the friction generated between the laundries and wash water and caused by rotation of the drum.

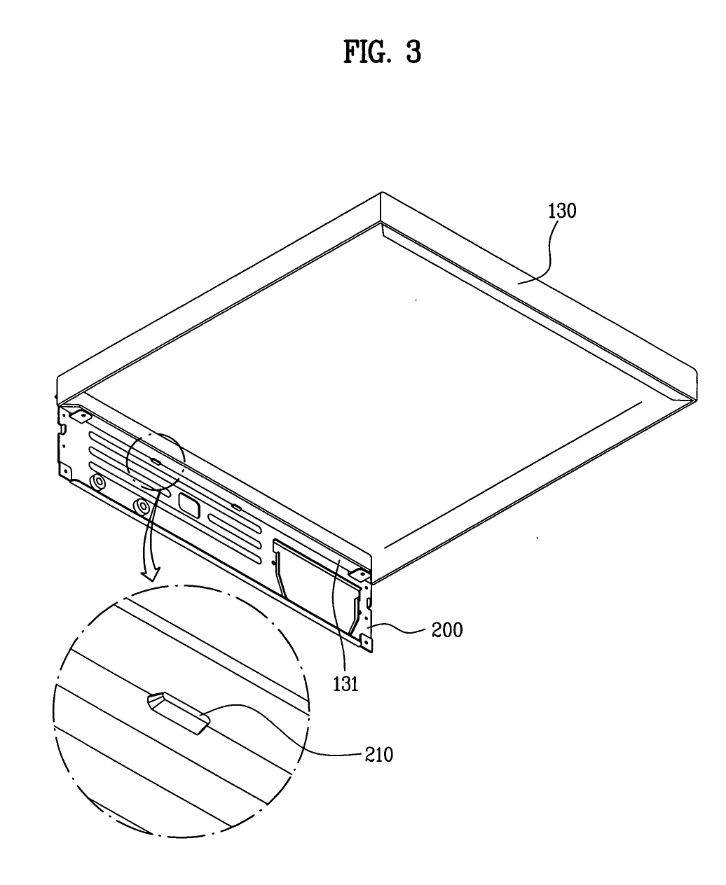

FIG. 3 illustrates a perspective view showing a supporting structure of a top cover in accordance with a first embodiment of the present invention.

As illustrated in FIG. 3, a panel frame 200 is provided at an upper front surface of the washing machine, and the panel frame 200 is coupled with a front portion of the top cover 130. In this case, at least one projecting member 210 is protruded rearward from an upper part of the panel frame 200 so as to load an end at a front side of the top cover 130. The panel frame 200 includes a metal material, and the projecting member 210 is formed at the upper part of the panel frame 200 by a lancing process in which the upper part of the panel frame 200 is horizontally cut off to a predetermined length and then the cut portion is pressed into the projecting member 210 from a front surface to a rear surface thereof.

A contacting part 131 is bent inward from a lower surface of an end portion of the top cover 130, the contacting part 131 is loaded on an upper surface of the projecting member 210.

Meanwhile, the top cover 130 includes an enameled sheet material. In more detail, the enameled whet material is formed by applying a layer made of a glass material on a metal plate such as a steal plate and treating with high-temperature heat so as to increase chemical endurance. It is desirable that the metal includes soft steel, case iron, aluminum, copper, and stainless steel.

The enameled layer is fragile and easy to be broken by impact from outside or bending of the metal. Accordingly, it is impossible to provide a projection at the front border of the top cover 130. Therefore, the projecting member 210 is formed at the panel frame and then the front end of the top cover 130 is loaded to the upper surface of the projecting member 210.

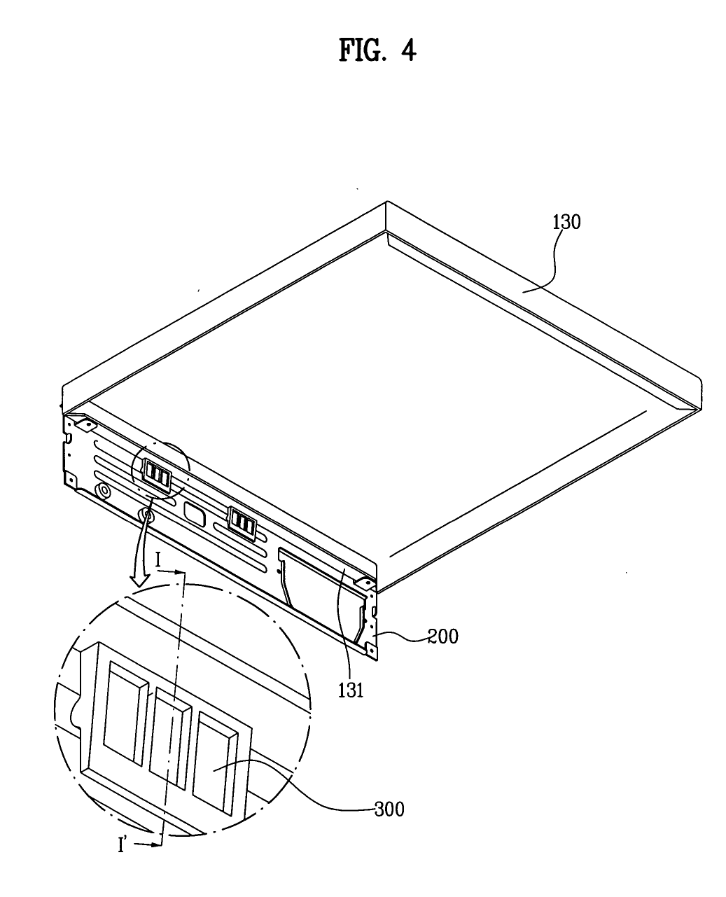

FIG. 4 illustrates a perspective view showing a supporting structure of a top cover in accordance with a second embodiment of the present invention. As illustrated in FIG. 4, the panel frame 200 is provided at an upper front part of the washing machine, and the top cover 130 is coupled with an upper part of the panel frame. In this case, the panel frame 200 improves stiffness of the upper front side of the washing machine and performs a role of supporting a front portion of the top cover 130. The top cover 130 is a base frame having a enameled surface and made of a metal material.

Meanwhile, at least one supporting member 300 is provided on a rear surface of the panel frame, at least one supporting member 300 having the front portion of the top cover 130 loaded thereto.

In more detail, the supporting member 300 is inserted and fixed on the upper part of the panel frame 200. In this case, the supporting member 300 may include a metal, however, desirably, include a plastic material having a predetermined stiffness. In more detail, the supporting member 300 desirably includes polyacetal (POM) being excellent fatigue proof, having toughness, and being abrasion proof. Wherein the POM is endurable both high and low temperatures. In connection with stress and strain, the POM is a plastic having a characteristic similar to metal, thereby being replicable with metal.

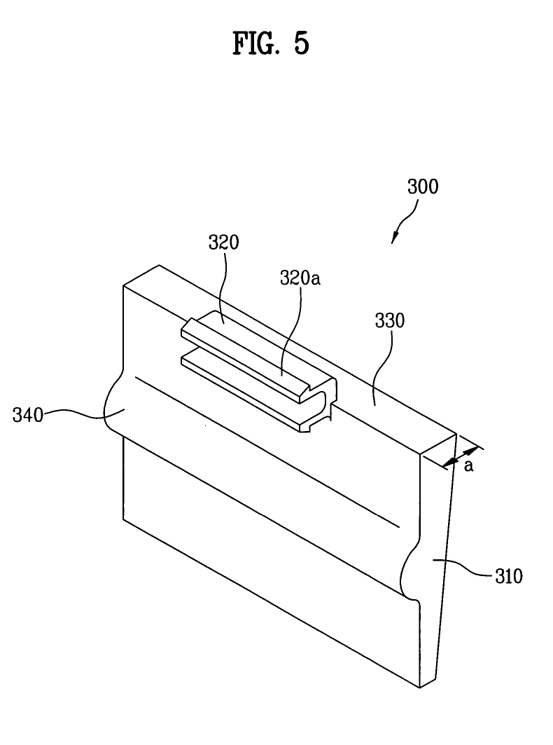

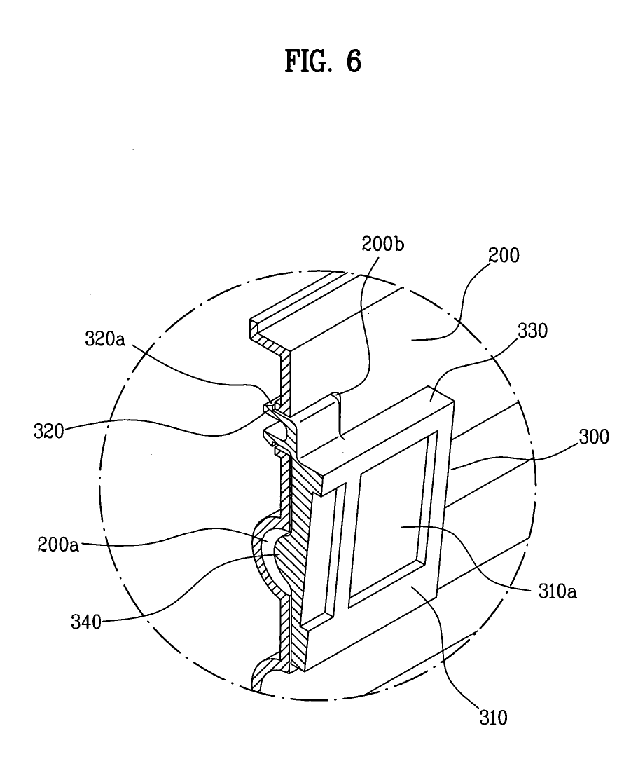

Hereinafter, a process of installing the supporting member 300 at the panel frame 200 will be described in detail. FIG. 5 illustrates a perspective view showing a supporting member in accordance with the present invention, and FIG. 6 illustrates a perspective view showing a sectional perspective view showing the supporting member coupled with a panel frame, in accordance with the present invention.

Referring to FIG. 5, a supporting member 300 in accordance with the present invention includes a body 310, and a hook 320 provided at a front upper end of the body 310.

In more detail, a protuberance 340 is formed on a front surface of the body, in a hill shape with a predetermined curvature. The protuberance 340 is loaded to a sunken member 200a formed on a rear surface of the panel frame 200.

Due to the combination the protuberance 340 and the sunken member 200a, the supporting member 300 is stably supported by a rear surface of the panel frame 200.

It is desirable that the hook 320 is formed in the center of the front upper end of the body 310, and the hook 320 is integrated into the body 310 by injection molding.

As illustrated in FIG. 6, it is desirable that at least one depressed member 310a is formed at the body 310 so as to maintain a predetermined stiffness and to save materials.

The hook 320 includes a section formed in a channel shape, and an end having a binding member 320a. An insertion hole 200b having the hook 320 inserted therein is formed at an upper part of the panel frame 200. When the hook 320 is inserted into the insertion hole 200b, the restraining member 320a is restrained by a rim of the insertion hole 200b and fixed thereon.

It is desirable that a width (a) of the body 310a becomes thicker toward an upper part thereof. In this case, the top cover 130 is loaded onto the upper surface of the body 310. In more detail, the width (a) of the upper surface 330 is changed according to a size or weight of the top cover 130.

As mentioned above, the hook 320 of the supporting member 300 is inserted into the insertion hole 200b formed at the panel frame 200 and fixed thereon, and the protuberance 340 provided at the body 310 of the supporting member 300 is supported by the sunken member 200a of the panel frame 200. Accordingly, the supporting member 300 enables supporting the weight of the top cover 130 not only by the hook 320 but also by the protuberance 340.

Meanwhile, a top surface 330 of the supporting member is loaded to the top cover 130, thereby preventing the top cover from being bent.

The drum washing machine having a structure for supporting the top cover in accordance with the present invention has effects as follows. Since a protuberance of a supporting member is provided at a panel frame, there is no need to form a projection at a border of the top cover. Accordingly, the present invention enables to prevent the top cover covered with enamel from being scratched or damaged.

The top cover covered with enamel is stably supported at an upper part of the panel frame via the protuberance or the supporting member.

The structure for supporting the top cover of a washing-machine as mentioned above is applicable not only to a drum type washing machine but also to a drum type dryer.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A drum washing machine comprising:
a top cover covering an upper surface of the washing machine;
a panel frame provided on an upper front portion of the top cover; and
at least one projecting member protruded rearward from the panel frame so as to support a front portion of the top cover.

2. The drum washing machine of claim 1, wherein the top cover comprises an enameled sheet metal.

3. The drum washing machine of claim 1, wherein the panel frame comprises a metal material and the projecting member is formed by applying a lancing process.

4. The drum washing machine of claim 1, wherein a bending member is bent inward from a front border of the top cover and loaded on an upper surface of the supporting member.

5. A drum washing machine comprising:
a panel frame provided at an upper front surface of the washing machine; and
at least one supporting member provided at the panel frame so as to support a front portion of the top cover.

6. The drum washing machine of claim 5, wherein the supporting member comprises:
a body closely loaded to a rear surface of the panel frame so as to load a front portion of the top cover to an upper surface thereof; and
a hook provided at the body and fixed on the panel frame.

7. The drum washing machine of claim 6, wherein the panel frame comprises at least one insertion hole, and the hook is inserted into the insertion hole and fixed therein.

8. The drum washing machine of claim 7, wherein an end of the hook is restrained by a border of the insertion hole.

9. The drum washing machine of claim 6, wherein a protuberance is provided on a front surface of the body and inserted into a sunken member formed on a rear surface of the panel frame.

10. The drum washing machine of claim 6, wherein at least one depressed member is formed on a surface of the body.

11. The drum washing machine of claim 5, wherein the top cover comprises an enameled sheet metal.

12. The drum washing machine of claim 5, wherein the supporting member comprises polyacetal.

13. The drum washing machine of claim 5, wherein a bending member is bent inward from a front border of the top cover and loaded on an upper surface of the supporting member.

14. A drum washing machine comprising:
a panel frame including an enameled sheet metal so as to cover an upper surface of the washing machine;
a panel frame provided on an upper front surface of the washing machine; and
at least one supporting member comprising:
a body closely loaded to a rear surface of the panel frame so as to load a front portion of the top cover to an upper surface thereof; and
a hook provided at the body and fixed on the panel frame.
